(19) United States
(12) Patent Application Publication
(10) Pub. No.: US 2020/0293485 A1
(43) Pub. Date: Sep. 17, 2020

(54) ON DEMAND MULTIPLE HETEROGENEOUS MULTICORE PROCESSORS

(71) Applicants: Moon J. Kim, Mountain View, CA (US); Youngju Shon, Seoul (KR)

(72) Inventors: Moon J. Kim, Mountain View, CA (US); Youngju Shon, Seoul (KR)

(21) Appl. No.: 16/818,390

(22) Filed: Mar. 13, 2020

Related U.S. Application Data
(60) Provisional application No. 62/817,687, filed on Mar. 13, 2019.

(51) Int. Cl. G06F 15/80; G06F 1/06

(52) U.S. Cl. CPC G06F 15/80; G06F 1/06

(57) ABSTRACT

Embodiments of the present invention provide a processor design that provides on-demand access to multiple (heterogeneous) types of multicore components, resulting in both increased performance and power reduction in a system on a chip integrated circuit. In a typical embodiment, the integrated circuit (e.g., processor) includes a first set of multicore processing components, where the first set of multicore processing components includes a plurality of homogeneous first components. The integrated circuit also includes a second set of multicore processing components includes a plurality of homogeneous second components that are functionally different (homogeneous) from the first components. Coupled to first set of components and the second set of components is a component controller that controls the first and second set of components, by selectively activating and deactivating the first and second components in response to changes in processing demand.

### FIELD OF THE INVENTION

In general, embodiments of the present invention relate to integrated circuit design. Specifically, embodiments of the present invention relate to an integrated circuit design that provides on-demand access to components in an integrated circuit having multiple homogenous processors or heterogeneous multicore processors.

### BACKGROUND OF THE INVENTION

In generic micro-processor design, integrated circuit or “chip” design has evolved from simple arrangements of electronic circuits to more complicated designs. More recently, these designs have spawned a concept known as “system on a chip” (SOC) in which the integrated circuit contains many homogenous components, or a variety of components needed for a particular purpose on a single substrate. The components may include central processing units (CPUs), cache memory, input/output ports, and/or any other secondary memory units. Moreover, in other SOC environments, more sophisticated components, such as those used for: signal processing (e.g., digital, analog, mixed-signal, radio frequency, and/or the like), graphics processing, application-specific processors (e.g., field-programmable gate arrays and/or the like), communications (PPC, RC, etc.), and/or any other component that may be included as part on an integrated circuit, may be included as part of the SOC.

### SUMMARY OF THE INVENTION

In general, embodiments of the present invention provide a processor design that provides on-demand access to multiple (heterogeneous) types of multicore components, resulting in both increased performance and power reduction in a system on a chip integrated circuit. In a typical embodiment, the integrated circuit (e.g., processor) includes a first set of multicore processing components, where the first set of multicore processing components includes a plurality of homogeneous first components. The integrated circuit also includes a second set of multicore processing components includes a plurality of homogeneous second components that are functionally different (homogeneous) from the first components. Coupled to first set of components and the second set of components is a component controller that controls the first and second set of components. The component controller does this by selectively activating the first components and the second components in response to increasing processing demand and selectively deactivating the first components and the second components in response to decreasing processing demand.

A first aspect of the present invention provides a processor, comprising: a first set of multicore processing components, the first set of multicore processing components including a plurality of homogeneous first components; a second set of multicore processing components, the second set of multicore processing components including a plurality of homogeneous second components that are functionally different from the first components; and a component controller coupled to the first set of components and second set of components, the component controller: selectively activating the first components and the second components in response to increasing processing demand; and selectively deactivating the first components and the second components in response to decreasing processing demand.

A second aspect of the present invention provides a system on a chip-type integrated circuit, comprising: a substrate; a first set of multicore processing components mounted on the substrate, the first set of multicore processing components including a plurality of homogeneous first components; a second set of multicore processing components mounted on the substrate, the second set of multicore processing components including a plurality of homogeneous second components that are functionally different from the first components; and a component controller mounted on the substrate and coupled to the first set of components and second set of components, the component controller: in response to the controller detecting decreasing demand for the first components, activating at least one first component; in response to the controller detecting increasing demand for the first components, deactivating at least one first component; in response to the controller detecting decreasing demand for the second components, activating at least one second component; and in response to the controller detecting increasing demand for the second components, deactivating at least one second component.

A third aspect of the present invention provides a system on a chip-type (SoC) integrated circuit, comprising: a substrate; a first set of multicore processing components mounted on the substrate, the first set of multicore processing components including a first number of homogeneous first components; a component controller mounted on the substrate and coupled to the first set of components, the component controller being configured to: receive an indication of a designated number of the homogeneous first components that have been designated for use in the SoC; and permanently enable a number of the first number of homogeneous first components that match the designated number and permanently disable any remaining ones of the first number of homogeneous first components that exceed the designated number.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a processor design according to an embodiment of the present invention.

FIG. 2 depicts another processor design according to an embodiment of the present invention.

FIG. 3 depicts a diagram of an exemplary hybrid-core platform block according to an embodiment of the present invention.

FIG. 4 depicts a scalability of an exemplary hybrid-core platform block according to an embodiment of the present invention.

FIG. 5 depicts a diagram demonstrating a first embodiment for communicating control signals to installed components according to an embodiment of the present invention.

FIG. 6 depicts a diagram demonstrating a second embodiment for communicating control signals to installed components according to an embodiment of the present invention.

FIG. 7 depicts a diagram demonstrating a third embodiment for communicating control signals to installed components according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The word “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

As indicated above, embodiments of the present invention provide a processor design that provides on-demand access to multiple (heterogeneous) types of multicore components, resulting in both increased performance and power reduction in a system on a chip integrated circuit. In a typical embodiment, the integrated circuit (e.g., processor) includes a first set of multicore processing components, where the first set of multicore processing components includes a plurality of homogeneous first components. The integrated circuit also includes a second set of multicore processing components includes a plurality of homogeneous second components that are functionally different (homogeneous) from the first components. Coupled to first set of components and the second set of components is a component controller that controls the first and second set of components. The component controller does this by selectively activating the first components and the second components in response to increasing processing demand and selectively deactivating the first components and the second components in response to decreasing processing demand . . . . In a typical embodiment, a processing core is coupled to a set (e.g., three) of I/O blocks. The processing core provides for selective activation and/or deactivation of any of the I/O blocks. Two of the I/O blocks are themselves coupled to individual voltage I/O components as well as individual external circuits. In one embodiment, the individual external circuits are themselves coupled to individual voltage control components. Among other things, the processor design disclosed herein provides: a power-down of the I/O supply to a sleep mode; a robust power saving strategy; adjustment of the I/O supply to achieve specific power-performance optimization; enablement of control to I/O-attached circuits; external circuit operating condition control to the I/O-attached circuit; control of the I/O-attached circuits' power supply voltage; and/or a combination of power-saving methods to achieve power-performance optimization in real time.

The inventors of the current invention have discovered a number of deficiencies in the current integrated circuit and processor designs. For example, in system on a chip-type solutions, the makeup of components that are installed on the integrated circuit is often determined based on a set of specific requirements for the chip. For example, if the developer expects to perform extensive graphics processing, one or more graphics processors of a particular model and/or from a specific vendor may be included. In contrast, if less extensive graphics processing is expected, no graphics processor or a graphics processor of a different model and/or from a different vendor may be included. However, these static decisions can lead to inefficiencies. For example, in the case where extensive graphics processing is expected, if the graphics processing does not occur or occurs only occasionally and the graphics processor(s) are always operational, resources are wasted. Similarly, if additional graphics processing is needed on the chip that has no graphics processor or a minimum specification graphics processor, performance may suffer.

These deficiencies can be even become even more evident in artificial intelligence (AI)-based applications. It such applications, the AI may be performing a task or set of tasks that requires a certain set of resources during one period of time and then a different task or set of tasks that requires a completely different set of tasks that requires a completely set of resources. As such, using static chipsets in AI applications can remove flexibility from the AI and disable the AI from being able to select the most efficient set of resources to perform the task at hand.

The current invention solves one or more of these deficiencies by providing a platform architecture for a hybrid digital system that has multiple heterogeneous core components. The design is applied to a multiple generic multiprocessor architecture such as Intel, RP, IBM, and ARM, with a set (e.g., one or more hybrid cores) of controlling components and a set of groups of sub-processing components. Under this arrangement, different vendor technology cores (e.g., Intel and IBM, etc.) and function components, such as memory, are organized in such a way that different technologies can collaborate as a system. These components can be activated and deactivated based on system demand, increasing performance and reducing wasted resources.

Because the teachings of current invention enable use of products from multiple different vendors in the same environment, efficiencies from known advantages provided by components from certain vendors can be utilized while known deficiencies from these or other vendor components can be avoided. Thus, digital system core technology can be provided to users on a scale that is currently not be available, allowing applications (e.g. media processing, codex, 3D, H.264, etc.) transparently to utilize an increased number of available components and allowing different technology upgrades to be performed transparently, allowing for platform continuity. In addition, the teachings of the present invention enable multiple vendor sources to be used for manufacturing and multiple packaging options to be utilized. Furthermore, the available of components when needed allows for scalable performance when performing operations, while saving power saving (e.g., through resource virtualization) then certain resources are not required, resulting in greater redundancy and higher chip yield (core virtualization). Moreover, the flexibility provided by the teachings of the present invention reduces the need for specialized application-based chips, allowing for greater code reusability, more stable product roadmaps, and reduced development time and shorter time-to-market for both hardware components and the software components that run on them.

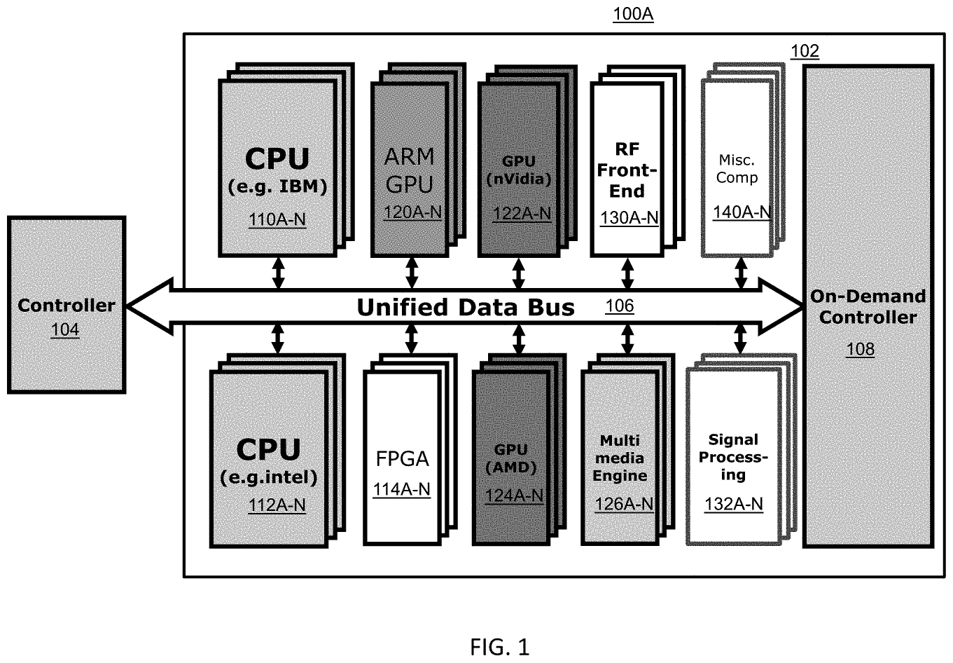

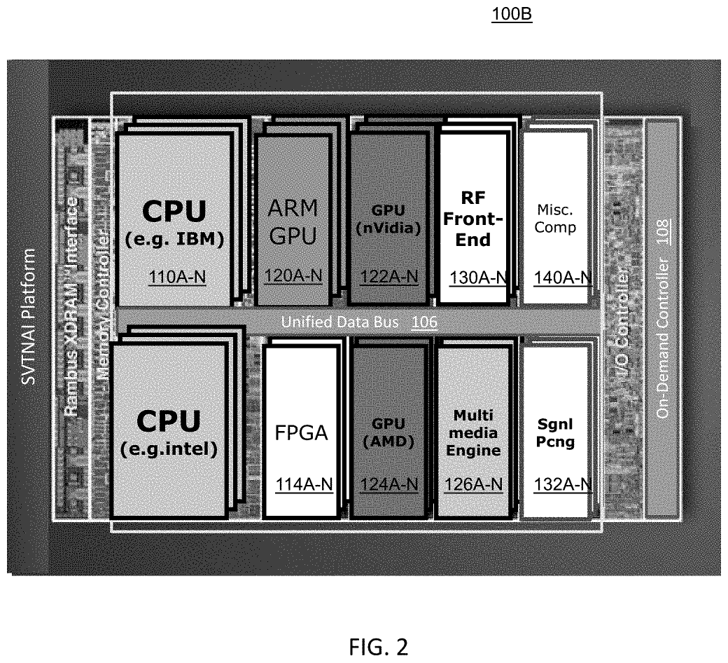

Referring now to FIGS. 1 and 2, processor design 100A and system on a chip (SoC) processor design 100B are shown according to an embodiment of the present invention. As depicted, processor design 100 includes installed components 102, a controller 104, and a bus 106 connecting and providing communications between installed components 102 and controller. Installed components 102 can include multiple sets of multicore processing components, with each set of multicore processing components including a plurality of homogeneous components (e.g., cores). As shown in the illustrative figure, components can include IBM CPUs 110A-N, Intel CPUs, 112A-N, field programmable gate arrays (FPGA) 114A-N, ARM GPUs 120A-N, nVidia GPUs 122A-N, AMD GPUs 124A-N, multimedia engines 126A-N, RF-Front-Ends 130A-N, Signal processing 132A-N, Misc. Components 140A-N, and/or the like.

To this extent, each component in a particular set of multicore processing components is a component that shares the make, model, type, specifications, characteristics, vendor, etc., with every other component in the set of multicore processing component. In contrast, the components in a different set of multicore processing components are different from those in the other set in at least one respect (e.g., make, model, type, specifications, characteristics, vendor, etc.). For example, components in components set 110A-N are CPUs from vendor IBM while those in component set 112A-N are CPUs from vendor Intel, while FPGA 114A-N is a specific-utility-type processor and not a general utility-type CPU like the other two. Similarly, the GPUs in component set 122A-N are GPUs from vendor nVidia while the GPUs in component set 124A-N are GPUs from vendor AMD. Further, while each of nVidia GPU 122A-N and AMD GPU 124A-N are GPUs, they are different types of GPUs from ARM GPU 120A-N and Multimedia Engine 126A-N. However, the GPUs are all different types or components from the processors. It should be understood that the types of components and vendors illustrated herein are provides only for the purpose of illustration and that components of other types and/or other vendors should not be seen as being excluded. Moreover, it should also be understood that processor design 100 could also and/or alternatively include other sets of components and/or individual component in its design.

In any case, included also in processor designs 100A-B is an on-demand controller 108, controls which components are activate at any one time based on demand for resources. In order to accomplish this, on-demand controller 108 can selectively activate one or more components in response to increasing processing demand. For example, if on-demand controller 108 determines that applications that are currently executing require multimedia processing, on-demand controller 108 can activate one or more multimedia engines 126A-N. Conversely, on-demand controller 108 can also selectively deactivate components that are not currently in demand. For example, if the applications that are currently executing require little or no RF functionality, controller can deactivate one or more or RF-Front-Ends 130A-N, in some cases shutting down RF-Front-Ends 130A-N entirely. On-demand controller 108 can use one or more factors in making its determination as to whether demand is increasing or decreasing. These factors can take into account the current usage of a particular set of installed components 102. For example, if the current usage of a set of installed components 102 exceeds a threshold (e.g., 90%) of total usage, on-demand controller 106 may determine that additional ones of the set of installed components 102 should be enabled. Alternatively, if the current usage of the set of installed components 102 falls below a particular threshold (e.g., the current usage has fallen a point that removal of one of the set of components would result in usage of less than 50% for the remaining components) on-demand controller 106 may determine that currently operating ones of the set of installed components 102 should be disabled. Additional factors used by on-demand controller 106 can include such things as: location, time of day, which applications are operating, which applications have recently ceased operating, and/or the like. In addition, machine learning and/or artificial intelligence (AI) can be used to recognize patterns and determine increased or decreased demand based on these patterns.

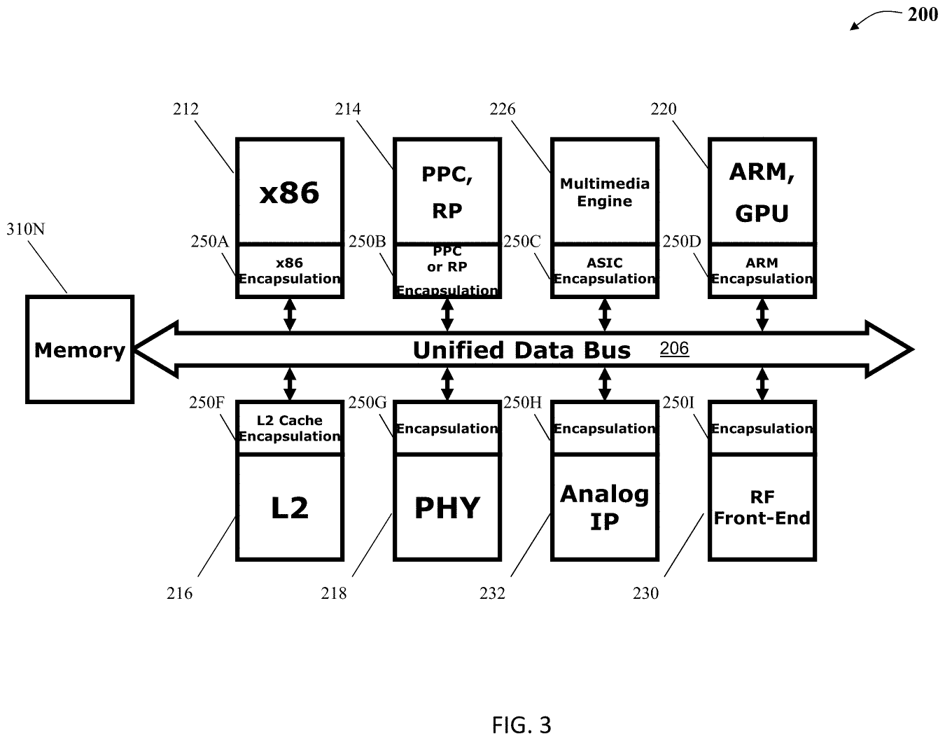

Referring now to FIG. 3, a diagram of an exemplary hybrid-core platform block 200 is depicted according to an embodiment of the current invention. As shown, hybrid-core platform block 200 has a installed components 102 (FIG. 1) of various types. As show, installed components 102 (FIG. 1) of exemplary hybrid-core platform block 200 sets of multicore processing components, along with sets of multicore memory components. To this end, as shown, installed components include x86 CPUs 212, PowerPC (PPC) and/or other CPU related processors (RP) 214, ARM GPUs 220, level 2 (L2) cache 216, physical layer (PHY) chips 218, multimedia engines 226, analog image processing (IP) 232, Radio Frequency (RF) Front-Ends 330.

Referring additionally to FIG. 1, as shown, installed components 102 are connected with a unified data bus 206, which provides communications between different ones of installed components 102, between installed components 102 and a memory 240, and between installed components 102 and on-demand controller 108, among other things. To accomplish this, installed components 102 (FIG. 1) are coupled to unified data bus 206 via encapsulation adapters 250A-I. Encapsulation adapters 250A-I perform data processing, including encapsulation, translation, and interpretation. Under at least one embodiment of the present invention, additional processing such as interpretation can be delegated to other cores (or the core itself in different threads). This allows unified data bus 206 to provide system integration of hybrid and heterogeneous cores using unified data bus architecture. Along these lines, the unified data bus can: be considered as a computational entity; accommodate out-of-entity virtualization, integrate heterogeneous hybrid entities with transparent translation; reconfigure network architecture in real-time; reconfigure bus configuration in real-time; delegate instruction set architecture mapping and interpretation; and facilitate data encapsulation, virtualization, and system optimization. Moreover, unified data bus 52 can provide: faster integration time; address, data, and instruction translation; core and bus control, status, and command; data bus-wide computation for operation; instruction interception and data bus computation; real-time data bus operation optimization; highly flexible data bus operation; and/or multi-level virtualization including out-of-entity virtualization.

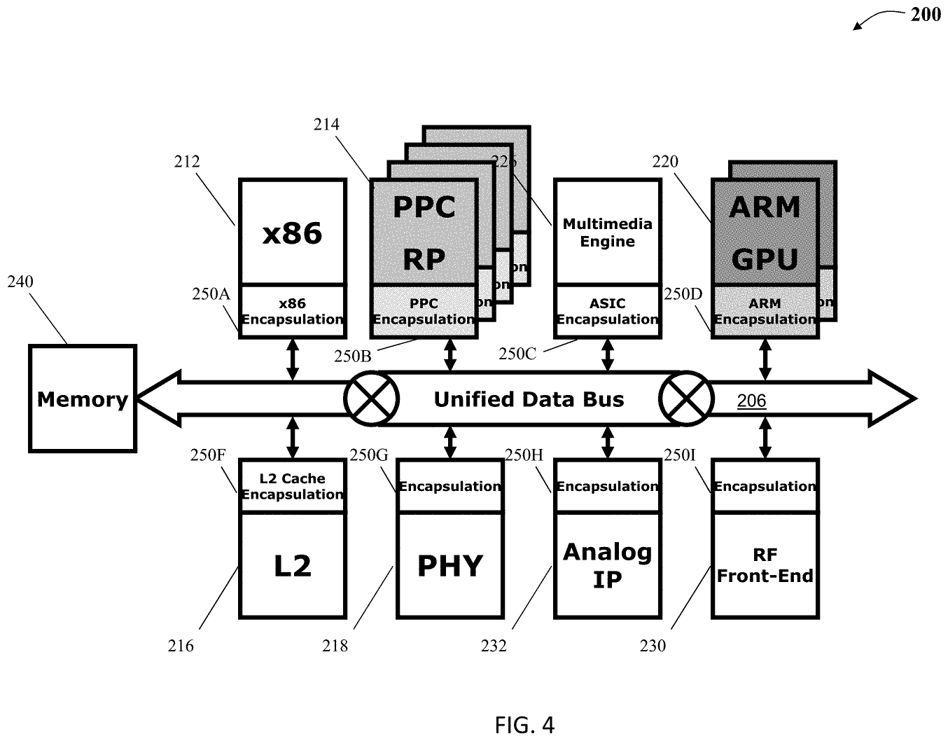

Referring now to FIG. 4, a diagram demonstrating scalability of exemplary hybrid-core platform block 200 is depicted according to an embodiment of the current invention. As shown, on-demand controller 108 (FIG. 1) has detected that there is increased demand for PPC and/or RP processors 214 and for ARM GPUs 220. Accordingly, on-demand controller 108 (FIG. 1) has sent a control signal to PPC and/or RP processors 214, to activate 3 additional PPC and/or RP processors, using one of a plurality of different solutions. Similarly, on-demand controller 108 (FIG. 1) has sent a control signal to ARM GPUs 220 to activate 1 additional ARM GPU 220, using one of a plurality of different solutions. Similarly, in cases in which a component is to be deactivated, on-demand controller 108 (FIG. 1) can send a command to deactivate the component, using one of a plurality of different solutions. In an embodiment, on-demand controller 108 (FIG. 1) can activate the component by sending a control signal to the component to activate the component along an external circuit corresponding to the component that connects the component and the on-demand controller 108.

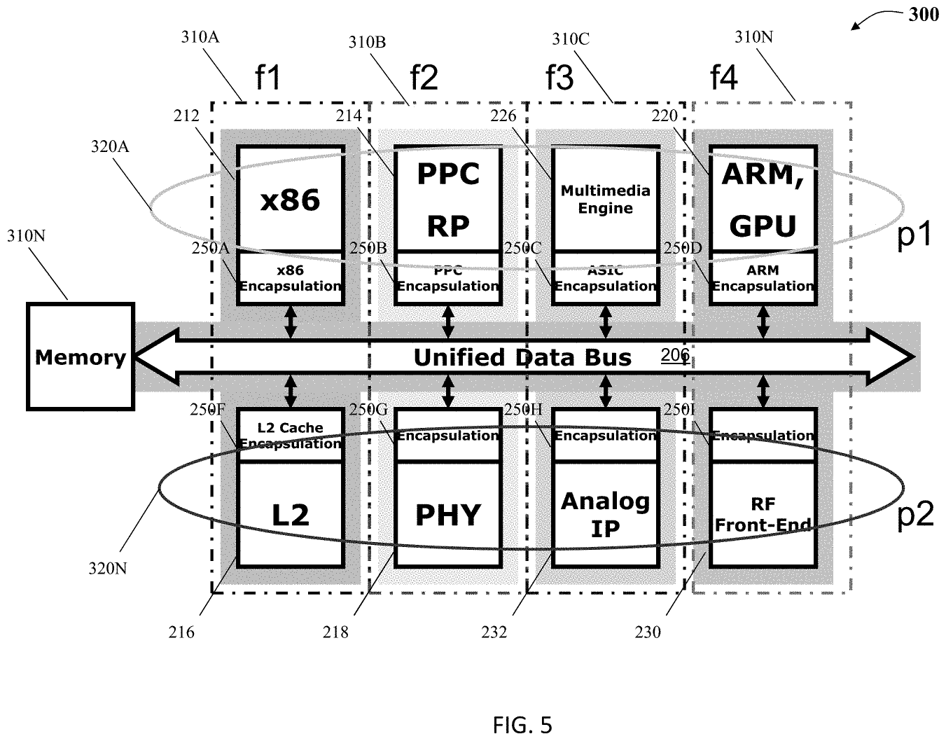

Referring now to FIG. 5, a diagram 300 demonstrating a first embodiment for communicating control signals to installed components 102 (FIG. 1) is depicted according to an embodiment of the current invention. As shown, on-demand controller 108 (FIG. 1) can communicate control signals using either or both of clock frequency or power supply voltages. To accomplish this installed components can be divided into a number of frequency zones 310A-N and/or power zones 320A-N. As illustrated, exemplary hybrid-core platform block 200 has been divided into four frequency zones (f1, f2, f3, f4) and two power zones (p1, p2).

Referring additionally to FIG. 1, each frequency zone can be controlled by a separate clock, which can be controlled by on-demand controller 106. Alternatively, circuits associated with each frequency zone 310N can modify the frequency sent from a common clock generator based on commands from the on-demand controller 106. These frequencies can be modified using any solution now known or later discovered, including, but not limited to increasing/decreasing the speed, phase, multiplier, and/or dynamic frequency of the clock signal. Similarly, each power zone can be controlled by a power supply, which can be controlled by on-demand controller 106. Alternatively, circuits associated with each power zone 310N can modify the frequency sent from a common power supply based on commands from the on-demand controller 106. The power can be modified using any solution now known or later discovered, including, but not limited to increasing/decreasing the voltage, amperage, and/or variance the supplied power. As shown, each set of installed components can be individually targeted based on location within a frequency one 310N a power zone 320N, or some combination thereof. In an embodiment, increasing the power to a particular set of components could be both a signal to engage additional ones of the particular set of components and also provide the additional power necessary to operate the additional components, while a reduction in power could be both a signal to disengage unused components and enable the system as a whole to save power. It should be understood that the depicted combination, orientation, number, etc., of frequency zones 310A-N and power zones 320A-N are used for purposes of example only and should not be construed as being limiting.

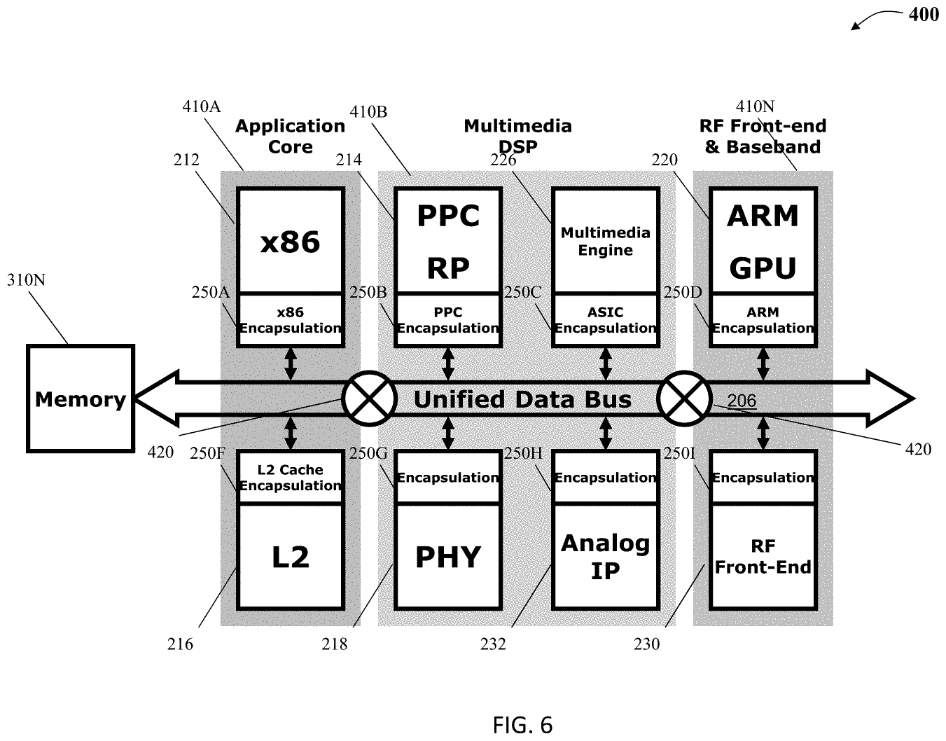

Referring now to FIG. 6, a diagram 400 demonstrating a second embodiment for communicating control signals to installed components 102 (FIG. 1) is depicted according to an embodiment of the current invention. As shown, unified data bus 206 has been segmented into a number of different domains 410A-N. Domains 410A-N can be segmented using one or more routers 420 that can be used by on-demand controller 106 to control each domain 410N individually. Domains 410A-N can be divided by function (e.g., the systems by which they are utilized), such that installed components 102 necessary to perform a particular commonly performed function are included in the same domain. As illustrated, three domains 410A-N have been created, an application core domain 410A, a multimedia digital signal processing (DSP) domain 410B, and an RF front-end & baseband domain 410N. To this extent, if on-demand controller 106 detected that a particular function that required multimedia DSP processing, on-demand controller 108 could direct a command via router(s) 420 directly to multimedia DSP domain 4106, instructing that more installed components within this domain be enabled, resulting in increased numbers of PPC/RC 214, multimedia engine 226, PHY 218, and analog IP 232 being enabled. It should be understood than any other number of domains 410A-N and/or solution for segmenting domains 410A-N can be envisioned.

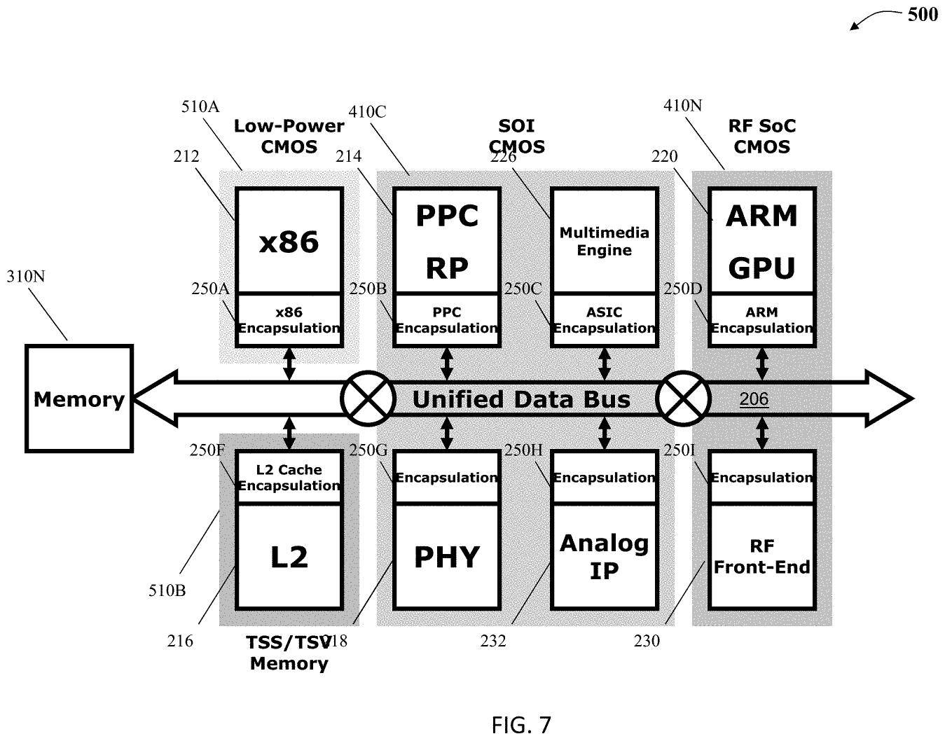

Referring now to FIG. 7, a diagram demonstrating a third embodiment for communicating control signals to installed components 102 (FIG. 1) is depicted according to an embodiment of the current invention. Similar to FIG. 6, unified data bus 206 has been segmented into a number of different domains 510A-N. In addition, domains 510A-N can be segmented using one or more routers 420 that can be used by on-demand controller 106 to control each domain 510N individually. However, in contrast to the system-based domains 410A-N of FIG. 6, domains 510A-N are based on the underlying technology/substrate integration of the installed components 102 in the domain 510A-N. To this extent, as illustrated, four domains 410A-N have been created, a low-power CMOS domain 510A, a TSS/TSV memory domain 510B, a SOI CMOS domain 510C and an RF SoC CMOS domain 510N.

The above-described example is only one of several way that the teachings of the present invention can be employed. For example, referring again to FIGS. 1-2, in an embodiment, on-demand controller 108 can control a plurality of homogeneous components in a SoC. For example, a batch of SoC systems can be manufactured with a predetermined number of CPU cores. Based on the number of CPU cores that are needed for a particular application, on demand controller can select n number of cores to be enabled on the system. In some applications, the CPU cores can be enabled dynamically (e.g., on-demand controller 108 can enable & disable the cores based on the computing resource demand), as described above. Alternatively, on-demand controller 108 could be used to permanently set the number of CPU cores utilized by the SoC or to do so until a further instruction is received by the SoC core to change the number of utilized CPU cores. For example: an SoC core may be constructed with a footprint packaging in which 10 cores are installed in a chip. Based on instructions in the on-demand controller 108, which the on demand controller 102 forwards to the CPU cores, and only 4 cores of the installed CPU cores may be enabled for market in an SoC core that has been designated as a quad core, while 2 CPU cores are enabled by the on-demand controller 108 for the dual core CPU. This allows various CPUs offerings to be provided using a single package.

In yet another embodiment, on-demand controller 108 of the present invention can be used to control a plurality of heterogeneous components in a SoC, in which multiple heterogeneous cores (n number CPUs, x number GPUs cores, etc) have been installed. In such an environment, on demand controller can select various numbers of different cores dynamically, as described above. Alternatively, on-demand controller 108 could be used to permanently set the various numbers of different cores. For example, assume a set of SoC chips have a single footprint packaging that has 4 CPU10 cores, 2 GPU cores, 2 FPGA installed in the chip. On demand controller 102 can be enable to forward a command that results in only 2 CPU cores, 1 GPU, 1 FPGA, for example, to be enabled for market. As with the previous embodiment, this has an advantage of allowing various hybrid-multicore processor offerings to be provided from a single SoC package.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A processor, comprising:
a first set of multicore processing components, the first set of multicore processing components including a plurality of homogeneous first components;
a second set of multicore processing components, the second set of multicore processing components including a plurality of homogeneous second components that are functionally different from the first components; and
a component controller coupled to the first set of components and second set of components, the component controller:
selectively activating the first components and the second components in response to increasing processing demand; and
selectively deactivating the first components and the second components in response to decreasing processing demand.

2. The processor of claim 1, wherein the first components are homogeneous central processing units.

3. The processor of claim 2, wherein the second components are selected from a group comprising: technologically different central processing units, graphics processing units, signal processing units, application-specific processing units, and multimedia engines.

4. The processor of claim 3, further comprising:
a third set of multicore processing components coupled to the component controller and controlled by the component controller, the third set of multicore processing components including a plurality of homogeneous third components,
wherein the third components are heterogeneous from the second components and perform a homogeneous function to the second components.

5. The processor of claim 4, wherein the third components are manufactured by a different manufacturer from the second components.

6. The processor of claim 5, wherein the second set of components is a plurality of homogenous graphics processing units manufactured by a first vendor and the third set of components is a plurality of homogeneous graphics processing units manufactured by a second vendor.

7. The processor of claim 1, the component controller further:
in response to the controller detecting increasing demand for the first components and decreasing demand for the second components, activating at least one first component and deactivating at least one second component.

8. The processor of claim 7, further comprising an external circuit coupled to each of the first components and the second components, wherein in response to the controller detecting increasing demand for a set of components, the controller sends a control signal along the external circuit corresponding to a component of the set of components to activate the component.

9. The processor of claim 7, further comprising a first voltage control component coupled to each of the first components and the and a second voltage control component coupled to each of the second components, wherein in response to the controller detecting decreasing demand for a set of components, the controller sends a command to reduce voltage to a component of the set of components.

10. The processor of claim 7, further comprising a first clock frequency control component coupled to each of the first components and a second clock frequency control component coupled to each of the second components, wherein in response to the controller detecting decreasing demand for a set of components, the controller sends a command to reduce voltage to a component of the set of components.

11. The processor of claim 7, further comprising a unified data bus that connects the first components and the second components, each of the first components and the second component having an encapsulation adapter that enables communication via the unified data bus.

12. The processor of claim 11, the unified data bus being segmented into a plurality of domains via a set of routers that communicate the command from the component controller directly to a set of multicore processing components in the domain.

13. The processor of claim 12, wherein the plurality of domains are segmented based on system function of the set of multicore processing components within a corresponding domain.

14. The processor of claim 13, wherein the plurality of domains are segmented based on a manufacturing technology of the set of multicore processing components within a corresponding domain.

15. A system on a chip-type integrated circuit, comprising:
a substrate;
a first set of multicore processing components mounted on the substrate, the first set of multicore processing components including a plurality of homogeneous first components;
a second set of multicore processing components mounted on the substrate, the second set of multicore processing components including a plurality of homogeneous second components that are functionally different from the first components; and
a component controller mounted on the substrate and coupled to the first set of components and second set of components, the component controller:
in response to the controller detecting decreasing demand for the first components, activating at least one first component;
in response to the controller detecting increasing demand for the first components, deactivating at least one first component;
in response to the controller detecting decreasing demand for the second components, activating at least one second component; and
in response to the controller detecting increasing demand for the second components, deactivating at least one second component.

16. A system on a chip-type (SoC) integrated circuit, comprising:
a substrate;
a first set of multicore processing components mounted on the substrate, the first set of multicore processing components including a first number of homogeneous first components;
a component controller mounted on the substrate and coupled to the first set of components, the component controller being configured to:
receive an indication of a designated number of the homogeneous first components that have been designated for use in the SoC; and
permanently enable a number of the first number of homogeneous first components that match the designated number and permanently disable any remaining ones of the first number of homogeneous first components that exceed the designated number.

17. The system of a chip-type integrated circuit of claim 16, further comprising:
a second set of multicore processing components mounted on the substrate and being coupled to component controller, the second set of multicore processing components including a plurality of homogeneous second components that are functionally different from the first components,
wherein the component controller is further configured to:
receive an indication of a second designated number of the homogeneous second components that have been designated for use in the SoC; and
permanently enable a number of the second number of homogeneous second components that match the second designated number and permanently disable any remaining ones of the second number of homogeneous second components that exceed the designated number.
